(19) United States
(12) Patent Application Publication
(10) Pub. No.: US 2012/0149589 A1
(43) Pub. Date: Jun. 14, 2012

(54) Epigentic Markers Associated with Substance Use Disorders

(76) Inventor: Kent Hutchison, Boulder, CO (US)

(21) Appl. No.: 13/326,014

(22) Filed: Dec. 14, 2011

Related U.S. Application Data
(60) Provisional application No. 61/422,734, filed on Dec. 14, 2010.

(51) Int. Cl. C40B 30/00

(52) U.S. Cl. 506/7

(57) ABSTRACT

DNA methylations markers are associated with brain and behavioral mechanisms that underlie substance abuse disorders. These methylation markers present novel measures for predicting and/or identifying effective treatment options, risk of cancer development, risk of developing substance abuse disorders, and substance-abuse related behaviors such as binge drinking. These markers may further be useful in developing novel pharmaceuticals and treatment methodologies and provide mechanisms for following the course of an individual's treatment, risks, or behaviors over time.

### BACKGROUND

The identification of biomarkers that are associated with the progression of disease and treatment outcomes is critically important for the success of personalized medicine (Hutchison, 2010). Recently, scientists have focused on epigenetic variation, and specifically changes in DNA methylation, as a promising class of biomarker that may apply to a range of disorders (for review see Petronis, 2010; Portela & Esteller, 2010). Methylation refers to the addition of methyl (CH3) groups to the cytosine of CpG dinucleotides. Many genes have very high concentrations of CpGs in their promoter regions, and in most normal cells these CpG “islands” are unmethylated. Methylation of CpG islands in promoter regions can dramatically alter gene expression. For many years, research focused heavily on the role of DNA methylation in cancer, but scientists have increasingly focused on the role of DNA methylation in psychiatric disorders (for review Tsankova et al., 2007; Bredy et al., 2010). In fact, the mechanisms of action for some existing psychiatric medications may involve epigenetic alterations (e.g., valproic acid).

Epigenetic biomarkers may be especially relevant for the study of neurobiological mechanisms that underlie the development of addiction. Animal studies indicate that drug-induced changes in epigenetic processes occur in the nucleus accumbens (NAc) and other drug reward regions (Moonat et al., 2010; Russo et al., 2009; Tsankova et al., 2007). For example, the accumulation of AFosB during chronic drug treatment has been shown to interact with distinct chromatin remodeling factors at specific promoters of genes that control reward neurons in the NAc (e.g., Borrelli et al., 2008). Other epigenetic factors implicated in the development of drug addiction include the repressor complex comprising methyl-CpG binding protein (MeCP2), which represses methylated DNA, is a key regulator of many basic aspects of neuronal plasticity in postmitotic neurons, and has been associated with loss of behavioral control in drug addiction (e.g., Im et al., 2010), and the transcription factor CREB, which has been shown to influence histone acetyltransferase (HAT) activity and may influence the positive and negative affective states of alcoholism (e.g., Pandey et al., 2008). Finally, epigenetic changes have been linked to changes in gene regulation in neurons and downstream processes such as memory and cognition that are relevant for drug use and addiction (for reviews see Tsankova et al., 2009; Graff & Mansuy, 2008). The overall conclusion emerging from this research is that epigenetic changes may play an important role in terms of long-term neurobiological changes (or “molecular and cellular memory”) that characterize addiction. If epigenetic changes do in fact play a prominent role in the molecular machinery that underlies addiction, epigenetic research may have important clinical implications for the development of new pharmacotherapies. Thus, DNA methylation may serve as important biomarker or treatment target.

### SUMMARY

The present disclosure provides DNA methylation markers useful for the analysis and treatment of alcohol use disorders, the analysis and treatment of substance use disorders more generally, and markers useful for predicting the success of medications that target dopamine receptors and may be used to treat substance use disorders, psychosis, bipolar disorder, or related disorders. According to an embodiment, these DNA markers may be used to identify and predict the level of success of various treatment options for an individual with an alcohol or substance use disorder. According to another embodiment, these markers may be used to identify and predict success of medications that target dopamine receptors in the treatment of substance use disorders, psychosis, bipolar disorder, or related disorders. According to still another embodiment, these DNA markers may be used to develop new treatments for alcohol or substance use disorders. According to a further embodiment, these DNA markers may be used to identify individuals at risk for the harmful effects of alcohol exposure, including, but not limited to, increased risks for development of alcohol-use related diseases such as cancer. According to a still further embodiment, these DNA markers may be used as a test to identify individuals who are currently binge drinking. According to yet another embodiment, these DNA markers may be used to identify individuals who are at risk for developing an alcohol use disorder.

### DETAILED DESCRIPTION

Tables 1 and 2 provide the results of the analysis of the association between specific methylation sites and the brain measure as well as measures of chronic exposure to alcohol (i.e. number of years of abuse), recent binge drinking (i.e. average drinks per drinking day) and loss of control over drinking (i.e. impaired control scale) across subsamples 1 and 2. Genes that are represented more than once were significant in more than one measure. While specific methylation sites are provided in the tables, these sites are correlated with other methylation sites in the same area. Thus, nearby sites are also likely to predict these measures. Column 1 identifies the name of the methylation site, column 2 identifies the chromosome on which the methylation site is located, and column 3 lists the associated gene. Column 4 identifies the distance between the marker and the transcription start site of the gene and columns 5 and 6 identify the size of the association between the marker and brain response in voxels of activation.

The DNA methylation biomarkers identified in Tables 1 and 2 were obtained by examining DNA methylations biomarkers across the genome for an association with neurobiological phenotypes related to alcohol use disorders (AUDS). Importantly, these phenotypes reflect the neurobiological mechanisms that are the focus of basic neuroscience research and have been shown to predict treatment outcomes. These brain-based phenotypes are measured by exposing individuals with alcohol use disorders to the taste of alcohol versus the taste of a novel appetitive control (litchi juice). Exposure to the taste of alcohol results in a robust blood oxygen level dependent (BOLD) response in the ventral tegmental area (VTA), striatum, and prefrontal cortex that can be measured with fMRI. This response is also clearly associated with severity and chronicity of alcohol abuse (Claus et al., 2011). Those results are consistent with numerous other studies on alcohol cues, and more broadly, with studies on brain networks that subserve the monitoring, prediction, and response to cues that signal reward.

TABLE 1
DNA methylation markers that were significantly associated
with functional brain measures or behavioral measures
in both subsample 1 and subsample 2.

| Name | CHR | Gene | Distance | Brain 1 | Brain 2 |
|---|---|---|---|---|---|
| cg00010193 | 4 | FLJ35816 | 56 | 26 | 47 |
| cg00014837 | 12 | ACRBP | 677 | 1635 | 1039 |
| cg00055233 | 9 | RLN1 | 196 | 7561 | 339 |
| cg00059225 | 5 | GLRA1 | 46 | 1235 | 1047 |
| cg00059225 | 5 | GLRA1 | 46 | 1235 | 1047 |
| cg00059225 | 5 | GLRA1 | 46 | 1235 | 1047 |
| cg00079056 | 9 | SPINK4 | 555 | 2096 | 1247 |
| cg00152644 | 1 | SPRR2E | 1235 | 16 | 740 |
| cg00393585 | 4 | FLJ31659 | 9 | 41 | 25 |
| cg00401678 | 19 | EMR3 | 1417 | 2101 | 392 |
| cg00521434 | 1 | GPR61 | 544 | 1341 | 887 |
| cg00536175 | X | GATA1 | 62 | 2591 | 346 |
| cg00548268 | 7 | NPTX2 | 779 | 3681 | 11524 |
| cg00548268 | 7 | NPTX2 | 779 | 3681 | 11524 |
| cg00548268 | 7 | NPTX2 | 779 | 3681 | 11524 |
| cg00564163 | 7 | STEAP4 | 227 | 290 | 51 |
| cg00564163 | 7 | STEAP4 | 227 | 290 | 51 |
| cg00662556 | 18 | GALR1 | | 2450 | 1681 |
| cg00687674 | 15 | TMEM84 | 58 | 32 | 170 |
| cg00842351 | 9 | TJP2 | 564 | 25 | 7 |
| cg00885506 | 9 | WDR31 | 225 | 99 | 8 |
| cg00891541 | 16 | SMPD3 | 917 | 28 | 27 |
| cg00967316 | 7 | PPP1R3A | 270 | 1062 | 1349 |
| cg01112778 | 5 | PPP2R2B | 27 | 1517 | 958 |
| cg01128603 | 11 | SF3B2 | 575 | 406 | 13 |
| cg01155039 | 14 | AMN | 810 | 2323 | 317 |
| cg01337047 | 18 | DSG1 | 939 | 1008 | 319 |
| cg01355520 | 2 | HADHA | 597 | 165 | 80 |
| cg01416012 | 2 | BAZ2B | 875 | 1800 | 1731 |
| cg01459453 | 1 | SELP | 195 | 8830 | 924 |
| cg01459453 | 1 | SELP | 195 | 8830 | 924 |
| cg01498098 | 13 | SACS | 150 | 1255 | 1528 |
| cg01530101 | 11 | KCNQ1DN | | 41 | 9 |
| cg01667702 | 17 | TRAPPC1 | 1339 | 273 | 16 |
| cg01708964 | 7 | MYL7 | 875 | 27 | 101 |
| cg01765641 | 3 | TBC1D5 | 511 | 28 | 69 |
| cg01775265 | 20 | RP11- | 529 | 22 | 59 |
| | | 49G10.8 | | | |
| cg01946401 | 6 | RUNX2 | 47 | 23 | 12 |
| cg02075593 | 6 | GSTA3 | 785 | 2208 | 388 |
| cg02091100 | 6 | GUCA1A | 145 | 2897 | 651 |
| cg02121427 | 3 | LRRC15 | 720 | 1072 | 1478 |
| cg02151301 | 20 | HM13 | 456 | 1679 | 254 |
| cg02169098 | 22 | XRCC6 | 1 | 214 | 16 |
| cg02255004 | 4 | GDEP | 121 | 0 | 2704 |
| cg02276665 | 5 | CTNNA1 | 665 | 338 | 109 |
| cg02286642 | 19 | ZNF254 | 97 | 559 | 146 |
| cg02431687 | 9 | C9orf90 | 739 | 25 | 64 |
| cg02442161 | 20 | PI3 | 139 | 1383 | 2310 |
| cg02510853 | 16 | PKMYT1 | 1233 | 490 | 48 |
| cg02630694 | 10 | C10orf7 | 1132 | 473 | 70 |
| cg02655204 | 13 | RB1 | | 208 | 26 |
| cg02682905 | 19 | FLJ38288 | 31 | 2103 | 429 |
| cg02701137 | 20 | DLGAP4 | 701 | 7 | 72 |
| cg02978737 | 22 | PVALB | 550 | 1 | 5 |
| cg02994956 | 22 | NEFH | 315 | 830 | 2844 |
| cg03017653 | 1 | TTC13 | 1287 | 386 | 17 |
| cg03021892 | X | SLC38A5 | 713 | 1588 | 837 |
| cg03054529 | 7 | SCRN1 | 561 | 1256 | 1515 |
| cg03148461 | 7 | BRAF | 502 | 60 | 18 |
| cg03382346 | 19 | ZNF611 | 110 | 1307 | 1242 |
| cg03417466 | 11 | TYR | 622 | 1168 | 643 |
| cg03491478 | 11 | MAPK8IP1 | 288 | 6 | 89 |
| cg03679581 | 9 | RLN2 | 69 | 3173 | 398 |
| cg03775246 | 5 | C5orf13 | 505 | 1241 | 503 |
| cg03804985 | 9 | SLC2A8 | 229 | 1046 | 383 |
| cg03837750 | 1 | LRRC44 | 329 | 59 | 64 |
| cg03958426 | 1 | MAPKAPK2 | 342 | 95 | 101 |
| cg04076481 | 19 | FLJ12949 | 179 | 886 | 48 |
| cg04084157 | 7 | VGF | 197 | 387 | 485 |
| cg04304130 | 6 | HERV-FRD | 65 | 0 | 252 |
| cg04456238 | 11 | WT1 | | 605 | 54 |
| cg04457481 | 20 | GNAS | | 4 | 63 |
| cg04570669 | 4 | APIN | 823 | 1720 | 267 |
| cg04576021 | 6 | HLA-DOB | 529 | 1410 | 320 |
| cg04622802 | 11 | LOC387758 | 244 | 3043 | 756 |
| cg04762213 | 6 | BAT2 | 709 | 231 | 4 |
| cg04810997 | 7 | TAS2R60 | 128 | 1603 | 865 |
| cg05023691 | 1 | RGS13 | 29 | 2251 | 900 |
| cg05113908 | X | GYG2 | 273 | 115 | 72 |
| cg05114625 | 17 | CDC27 | 215 | 66 | 22 |
| cg05206661 | 2 | FLJ33534 | 816 | 1072 | 707 |
| cg05294243 | 19 | KLK13 | 739 | 200 | 56 |
| cg05310071 | 17 | PIGL | 33 | 25 | 50 |
| cg05436231 | 1 | CD164L2 | 4 | 1699 | 120 |
| cg05480532 | 4 | TMPRSS11A | 984 | 1497 | 632 |
| cg05535113 | 16 | CHST4 | 480 | 13 | 25 |
| cg05593479 | 2 | TIGD1 | 220 | 334 | 62 |
| cg06131859 | 2 | KYNU | 64 | 7 | 16 |
| cg06168449 | 19 | DPF1 | 239 | 311 | 64 |
| cg06214007 | 1 | GBP6 | 309 | 83 | 24 |
| cg06244906 | 19 | ZIM2 | | 5 | 151 |
| cg06291867 | 10 | HTR7 | 509 | 866 | 116 |
| cg06504820 | 14 | DLK1 | | 1050 | 287 |
| cg06563300 | 12 | SLC17A8 | 183 | 33 | 70 |
| cg06566994 | 3 | ZNF167 | 329 | 76 | 58 |
| cg06646021 | 1 | RAB4A | 359 | 99 | 59 |
| cg06646021 | 1 | RAB4A | 359 | 99 | 59 |
| cg06796611 | 1 | IL24 | 45 | 1358 | 387 |
| cg06933072 | 1 | SAC | 389 | 1322 | 1532 |
| cg06971096 | 2 | PTPRN | 552 | 109 | 186 |
| cg07321605 | 17 | NSF | 1377 | 1511 | 591 |
| cg07338205 | 2 | G6PC2 | 62 | 1239 | 351 |
| cg07506795 | 16 | ZNF19 | 319 | 1 | 37 |
| cg07510080 | 10 | HIF1AN | 147 | 378 | 12 |
| cg07549715 | 20 | GNRH2 | 64 | 86 | 225 |
| cg07584959 | 19 | THRAP5 | 281 | 165 | 40 |
| cg07599644 | 11 | MGC34830 | 111 | 2214 | 1025 |
| cg07605143 | 19 | EMP3 | 799 | 1506 | 1172 |
| cg07660236 | 6 | ZNF96 | 375 | 12 | 49 |
| cg07694025 | 4 | SFRP2 | | 279 | 25 |
| cg07703337 | 19 | ZNF610 | 739 | 1230 | 772 |
| cg07713361 | 22 | APOL1 | 20 | 7 | 22 |
| cg07730329 | 5 | PCDHGA12 | 21 | 499 | 58 |
| cg07799434 | 19 | MGC2803 | 162 | 75 | 39 |
| cg07829804 | 12 | OLR1 | 550 | 1837 | 634 |
| cg07845392 | 17 | SLC25A10 | 1213 | 1941 | 287 |
| cg07871503 | 10 | RASGEF1A | 675 | 35 | 77 |
| cg08096010 | 2 | SAG | 69 | 1035 | 3109 |
| cg08126211 | 6 | KAAG1 | 589 | 1184 | 36 |
| cg08209133 | 4 | SLC10A4 | 175 | 1570 | 133 |
| cg08433538 | 9 | RALGPS1 | 339 | 3071 | 313 |
| cg08460026 | 2 | CTLA4 | 37 | 28 | 48 |
| cg08510456 | 3 | BSN | 914 | 32 | 14 |
| cg08525145 | 1 | RLN3R2 | 140 | 91 | 108 |
| cg08657449 | 8 | TM7SF4 | 393 | 1260 | 526 |
| cg08749917 | 3 | RTP1 | 12 | 87 | 88 |
| cg08749917 | 3 | RTP1 | 12 | 87 | 88 |
| cg08784110 | 6 | MAS1 | 28 | 1175 | 297 |
| cg08789630 | 10 | MYST4 | 823 | 1246 | 261 |
| cg08818385 | 2 | FAHD2A | 763 | 1978 | 378 |
| cg08906015 | 19 | MGC15476 | 89 | 1096 | 1207 |
| cg09212058 | 2 | PRKD3 | 763 | 1668 | 1368 |
| cg09222115 | 2 | OTOS | 307 | 9 | 46 |
| cg09419670 | 9 | PSMD5 | 460 | 2980 | 461 |
| cg09457245 | 12 | ZNF385 | 269 | 5 | 138 |
| cg09458394 | 1 | RABGGTB | 90 | 97 | 12 |
| cg09511421 | 4 | NDST4 | 161 | 1795 | 267 |
| cg09511421 | 4 | NDST4 | 161 | 1795 | 267 |
| cg09538287 | 10 | CTNNA3 | 109 | 415 | 12 |
| cg09547190 | 9 | C9orf89 | 923 | 461 | 310 |
| cg09555217 | 11 | SMAP | 294 | 65 | 63 |
| cg09599653 | 13 | ARL11 | 422 | 1014 | 1056 |
| cg09604428 | 3 | PB1 | 1425 | 1423 | 377 |
| cg09781594 | 2 | LOC339789 | 839 | 1021 | 339 |
| cg09809672 | 1 | EDARADD | 2 | 178 | 49 |
| cg09809672 | 1 | EDARADD | 2 | 178 | 49 |
| cg09936561 | 4 | DRD5 | 20 | 1845 | 81 |
| cg09949775 | 19 | COMP | 7 | 1477 | 527 |
| cg10036895 | 10 | MGMT | | 1249 | 744 |
| cg10177528 | 1 | TRAF5 | 319 | 1416 | 319 |
| cg10235817 | 4 | ADRA2C | 259 | 262 | 365 |
| cg10269439 | 2 | IL1F7 | 34 | 2075 | 442 |
| cg10384134 | 19 | RPS9 | 116 | 25 | 11 |
| cg10431340 | 1 | MPZ | 636 | 2100 | 721 |
| cg10468702 | 19 | PTGER1 | 965 | 242 | 2093 |
| cg10585462 | 4 | C4orf7 | 51 | 1127 | 269 |
| cg10620457 | 1 | C8B | 422 | 1380 | 1615 |
| cg10693071 | 5 | TRIM36 | 179 | 27 | 67 |
| cg10906135 | 19 | GLTSCR1 | 467 | 2511 | 1591 |
| cg10936230 | 15 | RAB27A | 889 | 21 | 42 |
| cg10964421 | 8 | TNFRSF10D | | 1095 | 3212 |
| cg10977115 | 11 | CRTAM | 216 | 1218 | 321 |
| cg10995925 | 6 | LTA | 492 | 1905 | 595 |
| cg11120551 | 1 | CHD1L | 338 | 81 | 42 |
| cg11126134 | 13 | FLJ14834 | 24 | 5668 | 401 |
| cg11126134 | 13 | FLJ14834 | 24 | 5668 | 401 |
| cg11161873 | 7 | FLJ39575 | 103 | 1801 | 301 |

TABLE 2
DNA methylation markers that were significantly associated with measures of impaired
control over drinking, binge drinking, or number of years of alcohol abuse.

| | | | | Base | | Years | |
|---|---|---|---|---|---|---|---|
| | Name | Chr | Gene | Location | Control | Drinking | tlfbavgd |
| Impaired | cg00548268 | 7 | NPTX2 | 98083766 | −0.27 | 0.39 | 0.12 |
| Control | cg06572160 | 19 | KCNC3 | 55523713 | −0.26 | 0.19 | 0.21 |
| | cg10523019 | 2 | RHBDD1 | 227408702 | −0.26 | 0.25 | 0.17 |
| | cg11126134 | 13 | FLJ14834 | 30378304 | −0.26 | 0.29 | 0.22 |
| | cg12758687 | 11 | DRD2 | 112851537 | −0.27 | 0.25 | 0.18 |
| | cg12782180 | 7 | LEP | 127668168 | −0.27 | 0.24 | 0.15 |
| | cg12799895 | 7 | NPTX2 | 98084588 | −0.31 | 0.43 | 0.20 |
| | cg16463460 | 11 | WT1 | 32411294 | −0.26 | 0.26 | 0.14 |
| | cg17861230 | 19 | PDE4C | 18204901 | −0.29 | 0.46 | 0.18 |
| | cg20831708 | 10 | SEC31L2 | 102269363 | −0.26 | 0.37 | 0.19 |
| | cg27553955 | 2 | KCNG3 | 42573830 | −0.28 | 0.36 | 0.15 |
| Binge | cg00415993 | 5 | F2RL2 | 75954944 | −0.09 | −0.01 | 0.26 |
| Drinking | cg00564163 | 7 | STEAP4 | 87773915 | −0.22 | 0.07 | 0.27 |
| | cg00842351 | 9 | TJP2 | 70979473 | −0.15 | −0.02 | 0.26 |
| | cg00911351 | 5 | PCDHGB4 | 140747439 | −0.23 | 0.23 | 0.26 |
| | cg02157306 | 4 | ELMOD2 | 141664509 | −0.13 | −0.05 | 0.25 |
| | cg02169098 | 22 | XRCC6 | 40347240 | −0.17 | −0.05 | 0.26 |
| | cg02784848 | 19 | FLJ22688 | 55008690 | −0.09 | 0.05 | 0.26 |
| | cg03389111 | 12 | HRB2 | 74191639 | −0.11 | −0.04 | 0.27 |
| | cg04076481 | 19 | FLJ12949 | 10537881 | −0.16 | 0.02 | 0.26 |
| | cg04384398 | 22 | PMM1 | 40316279 | −0.11 | −0.10 | 0.25 |
| | cg06168449 | 19 | DPF1 | 43406389 | −0.14 | −0.02 | 0.26 |
| | cg06971096 | 2 | PTPRN | 219881835 | −0.17 | 0.03 | 0.26 |
| | cg08190044 | 1 | ATP8B2 | 152564959 | −0.15 | 0.02 | 0.28 |
| | cg09555217 | 11 | SMAP | 16716476 | −0.14 | 0.05 | 0.26 |
| | cg10146929 | 6 | HIST1H1A | 26125918 | −0.14 | −0.01 | 0.26 |
| | cg10384134 | 19 | RPS9 | 59396654 | −0.07 | 0.02 | 0.26 |
| | cg10586599 | 1 | ORC1L | 52642868 | −0.10 | −0.03 | 0.25 |
| | cg10691259 | 1 | TRSPAP1 | 28752445 | −0.13 | 0.01 | 0.27 |
| | cg10905918 | 10 | RPS24 | 79463533 | −0.09 | −0.03 | 0.25 |
| | cg13206017 | 3 | SST | 188870919 | −0.13 | −0.02 | 0.25 |
| | cg13599477 | 10 | NET1 | 5478485 | −0.11 | −0.05 | 0.26 |
| | cg13759143 | 11 | EXPH5 | 107969312 | −0.12 | −0.10 | 0.26 |
| | cg14081015 | 5 | RIOK2 | 96544759 | −0.14 | 0.05 | 0.27 |
| | cg14717946 | 1 | RBBP5 | 203357464 | −0.16 | 0.02 | 0.29 |
| | cg15846718 | 6 | COX7A2 | 76010027 | −0.13 | −0.03 | 0.25 |
| | cg18302652 | 4 | IL8 | 74825056 | −0.15 | −0.05 | 0.25 |
| | cg19093820 | 3 | GPR156 | 121445898 | −0.12 | −0.11 | 0.27 |
| | cg19515518 | 11 | TMEM80 | 684717 | −0.21 | 0.05 | 0.27 |
| | cg21263122 | 14 | SSTR1 | 37746846 | −0.13 | 0.03 | 0.25 |
| | cg21615127 | 1 | TMCO4 | 19999462 | −0.08 | −0.04 | 0.25 |
| | cg21644826 | 16 | ACSM3 | 20682853 | −0.09 | −0.06 | 0.26 |
| | cg22464423 | 19 | IGSF4C | 48836177 | −0.15 | −0.08 | 0.25 |
| | cg22511947 | 2 | FN1 | 216009803 | −0.12 | −0.01 | 0.27 |
| | cg22832044 | 16 | CDH1 | 67329500 | −0.11 | −0.05 | 0.26 |
| | cg23392730 | 10 | CHCHD1 | 75211351 | −0.12 | −0.07 | 0.26 |
| | cg24091698 | 16 | ERCC4 | 13921221 | −0.14 | −0.01 | 0.25 |
| | cg24358529 | 1 | PPIE | 39977249 | −0.13 | 0.03 | 0.25 |
| | cg25842633 | 22 | SCUBE1 | 42068371 | −0.20 | 0.04 | 0.26 |
| | cg25958361 | 2 | LOC129531 | 99163964 | −0.12 | −0.04 | 0.25 |
| Years | cg00059225 | 5 | GLRA1 | 151284550 | −0.24 | 0.32 | 0.19 |
| Drinking | cg00107187 | 14 | FLJ42486 | 104142043 | −0.20 | 0.25 | 0.11 |
| | cg00201234 | 3 | FBLN2 | 13565968 | −0.19 | 0.31 | 0.16 |
| | cg00548268 | 7 | NPTX2 | 98083766 | −0.27 | 0.39 | 0.12 |
| | cg02655204 | 13 | RB1 | 47938051 | −0.11 | 0.31 | 0.04 |
| | cg02994956 | 22 | NEFH | 28206534 | −0.19 | 0.27 | 0.09 |
| | cg06421800 | 9 | CDKN2B | 21996228 | −0.23 | 0.30 | 0.15 |
| | cg06646021 | 1 | RAB4A | 227473143 | −0.24 | 0.30 | 0.09 |
| | cg07533148 | 1 | TRIM58 | 246087435 | −0.20 | 0.28 | 0.21 |
| | cg07871503 | 10 | RASGEF1A | 43083048 | −0.01 | 0.32 | 0.00 |
| | cg08072716 | 3 | GPR62 | 51964732 | −0.17 | 0.25 | 0.14 |
| | cg08749917 | 3 | RTP1 | 188398014 | −0.24 | 0.31 | 0.17 |
| | cg09118625 | 1 | DIRAS3 | 68285559 | −0.15 | 0.27 | 0.06 |
| | cg09222115 | 2 | OTOS | 240728439 | −0.16 | 0.29 | 0.06 |
| | cg09786257 | 5 | PCSK1 | 95794451 | −0.16 | 0.27 | 0.15 |
| | cg09830866 | 16 | C16orf24 | 711715 | −0.19 | 0.25 | 0.13 |
| | cg10235817 | 4 | ADRA2C | 3738353 | −0.20 | 0.30 | 0.17 |
| | cg10468702 | 19 | PTGER1 | 14446209 | −0.15 | 0.27 | 0.08 |
| | cg11126134 | 13 | FLJ14834 | 30378304 | −0.26 | 0.29 | 0.22 |
| | cg12335708 | 2 | DPP4 | 162639249 | −0.13 | 0.28 | 0.11 |
| | cg12439773 | 11 | SLC22A6 | 62508695 | −0.16 | 0.27 | 0.05 |
| | cg12799895 | 7 | NPTX2 | 98084588 | −0.31 | 0.43 | 0.20 |
| | cg13434842 | 8 | GATA4 | 11605305 | −0.24 | 0.37 | 0.24 |
| | cg16463460 | 11 | WT1 | 32411294 | −0.26 | 0.26 | 0.14 |
| | cg17861230 | 19 | PDE4C | 18204901 | −0.29 | 0.46 | 0.18 |
| | cg19497444 | 11 | SLC22A18 | 2887370 | −0.11 | 0.28 | 0.10 |
| | cg19945840 | 1 | B3GALT6 | 1157899 | −0.20 | 0.45 | 0.20 |
| | cg20831708 | 10 | SEC31L2 | 102269363 | −0.26 | 0.37 | 0.19 |
| | cg21992250 | 11 | SLC15A3 | 60475285 | −0.22 | 0.29 | 0.22 |
| | cg22172494 | 11 | H19 | 1973938 | −0.11 | 0.30 | 0.02 |
| | cg23293787 | 20 | DPM1 | 49009789 | −0.14 | 0.27 | 0.04 |
| | cg23540745 | 6 | HIST1H4G | 26355112 | −0.01 | 0.26 | −0.06 |
| | cg24507762 | 20 | KCNB1 | 47533297 | −0.18 | 0.25 | 0.09 |
| | cg25002911 | 13 | RB1 | 47937987 | −0.09 | 0.27 | 0.11 |
| | cg25148589 | 4 | GRIA2 | 158361386 | −0.20 | 0.29 | 0.09 |
| | cg26050734 | 1 | TNRC4 | 149955656 | −0.13 | 0.27 | 0.13 |
| | cg26372517 | 1 | TFAP2E | 35811746 | −0.20 | 0.32 | 0.10 |
| | cg26687173 | 19 | LOC126248 | 38314931 | −0.14 | 0.27 | 0.05 |
| | cg26808606 | 3 | COX17 | 120878907 | −0.06 | 0.26 | −0.05 |
| | cg27038439 | 4 | MSX1 | 4915221 | −0.11 | 0.31 | 0.03 |
| | cg27504117 | 2 | ANKMY1 | 241146336 | −0.14 | 0.26 | 0.02 |
| | cg27553955 | 2 | KCNG3 | 42573830 | −0.28 | 0.36 | 0.15 |

Rather than taking an apriori hypothesis-driven approach to this work, the present research was based on an agnostic approach to the analysis of the array data, emphasizing replication in a second dataset. The objective was to identify the biomarkers with the greatest empirical support. To that end, data from 300 individuals with alcohol use disorders were analyzed in the current study. To facilitate a test of replication, the sample was split into matching halves on n=148 and n=152. DNA was extracted from saliva samples. The Illumina 27.7 k methylation array was collected on a subsample of the first 152 DNA samples. Prior to the analyses described below, the distribution for each methylation marker was examined. Only methylation markers that were normally distributed (e.g., skewness less than 2, kurtosis less than 4) without a transformation were analyzed further in the present study, leaving 5026 methylation markers for subsequent analyses.

The first set of analyses examined the degree to which individual methylation markers were associated with activation of the brain in the alcohol vs. control contrast. Markers that were associated with clusters of 1000 voxels or more in subsample 1 were identified. In the second set of analyses, markers that were significantly associated with a measure of chronic alcohol abuse (i.e., number of years of regular use) were identified. In the third set of analyses, markers that were associated with acute binge drinking were identified (i.e., average number of drinks per drinking day). Finally, analyses also identified markers associated with a measure of loss of control over drinking (i.e., impaired control scale).

The same analyses were conducted in subsample 2 to determine which markers replicated in the second sample. Accordingly, Tables 1 and 2 present a final list of markers that demonstrated significant results in one or more of these measures across subsamples. It will be noted that a marker is represented more than once in the tables if it demonstrated replication in more than one measure. The findings from both subsample 1 and subsample 2 strongly support an association between a number of DNA methylation sites and chronic alcohol abuse. In subsequent analyses, we also controlled for the effect of age. In this analysis, one of the strongest findings to emerge was the association between cg12758687, which is close to the DRD2 gene, and loss of control over drinking as well as BOLD response to alcohol cues. Further analyses were conducted to determine whether this methylation marker was also associated with days to relapse to heavy drinking after treatment with olanzapine (placebo, 2.5 mg, or 5 mg) in a subsample of 51 patients. This analysis suggested a dose response relationship with correlation coefficients of r=−0.35 across all conditions, −0.32 in the placebo condition, −0.40 in 2.5 mg condition, and −0.50 in the 5 mg condition. All together, these analyses suggest that DRD2 methylation may be a strong predictor of treatment response. More generally, this specific marker may predict responses to medications like olanzapine that target dopamine receptors (e.g., ariprazole, quetiapine, etc.) which are often used to treat psychosis as well as bipolar disorder and related disorders.

One of the other strong findings was related to methylation of NPTX2 and functional changes in the parietal cortex and precuneus/posterior cingulate after exposure to alcohol cues. In fact the findings suggest that a greater history of alcohol abuse is associated with greater methylation 5′ to the transcription start site for NPTX2. In turn, greater methylation of NPTX2 is associated with increased BOLD response to the presentation of alcohol cues. In both samples, analyses strongly supported a model in which changes in methylation of NPTX2 mediates the association between the number of years of regular alcohol consumption and functional changes in BOLD response to alcohol cues. Furthermore, greater methylation of NPTX2 was strongly associated with a behavioral measure of failure to control alcohol consumption in both samples, suggesting that NPTX2 may be involved in the loss of control over use, which is a hallmark of addiction.

NPTX2 is the gene that encodes neuronal activity regulated pentraxin (Narp or NP2) which is an immediate early gene product that facilitates the clustering of alphaamino-3-hydroxy-5-methyl-4-isoxazolepropionic acid (AMPA) receptors at excitatory synapses in an activity dependent fashion (Tsui et al., 1996). Thus, NPTX2 may play an important role in synaptic plasticity. Several recent studies have utilized NPTX2 knockout (KO) animal models to examine the role of Narp in synaptic plasticity as it relates to addiction. Recent work suggests that Narp regulates the behavioral and cellular adaptations produced by chronic cocaine administration (Pacchioni & Kalivas, 2009). More specifically, the conclusion of this work was that a loss of pentraxins are involved in the fine tuning of glutamate signaling and plasticity, via a decrease in AMPAR function, which may differentially affect cocaine-induced neuroadaptations and behavioral responses. It follows that NPTX2 may play an important role in long lasting neuroadaptations and behavioral effects that result from chronic use of drugs of abuse. A recent study that used NPTX2 KO mice to examine the role of NPTX2 in the neuroadaptations that result from morphine use supports and extends these conclusions. In this study, the deletion of Narp clearly diminished the animals' ability to extinguish learning, even though it did not disrupt the acquisition of conditioned associations (Crombag et al., 2009). Finally, a recent study using food reward paradigms has indicated that the loss of Narp in KO animals interferes with their ability to update representations of the motivational properties of reinforcers and use those representations to alter behavior (Johnson et al., 2007). In sum, the available basic science studies strongly support a role for NPTX2 in neuroadaptations involved in chronic consumption of drugs of abuse and suggest that the a reduction in Narp levels may result in an inability to extinguish responding to drug related cues.

The animal research performed to date has not examined specific regions that may be involved in these deficits. However, others have suggested that prelimbic regions, and specifically, regions that integrate sensory information with reward information may be involved in these effects, primarily because these regions are critical for updating representations of stimulus value and response extinction (see Johnson et al., 2007). Based on the above work, it would be expected that the parietal cortex, posterior cingulate, BLA, thalamus, and OFC may be particularly sensitive to changes in Narp. The data suggest that methylation of NPTX2 is associated with significant differences in some of these same regions and is associated with functional changes in the neuronal circuitry that underlies the incentive value of alcohol cues and associated with loss of control over alcohol consumption. A logical interpretation is that chronic alcohol abuse leads to increased methylation of NPTX. The methylation of NPTX may lead to a reduction in gene expression and Narp, which in turn leads to an inability to update representations or learn new associations regarding the incentive value of alcohol, which manifests behaviorally as a loss of control over consumption. This interpretation is also consistent with the observed association between self-reported loss of control over alcohol consumption and methylation of NPTX2.

Thus, elevated methylation of NPTX2 may represent an important biomarker that indicates it may be more difficult for an individual to extinguish drug use behavior. Furthermore, NPTX2 and Narp may be important targets for the development of new pharmacotherapies. A medication that targets the NPTX2 protein may influence extinction of drinking behavior and have potential as a pharmacotherapy for alcohol dependence or addiction more generally.

Two additional major findings included methylation sites in GLRA1 and SELP. Both of these genes are also known to modulate synaptic plasticity. In fact, many of the genes identified in Tables 1 and 2 are known to influence plasticity and hence the neuroadaptations that result from chronic alcohol or drug abuse. As such, they represent important treatment targets and biomarkers that may predict a patient's response to existing pharmacotherapies or new pharmacotherapies for alcohol dependence. For example, it is likely that these biomarkers may predict responses to naltrexone, topiramate, or medication in development that target the opioid, dopamine, or glutamate systems in the brain (e.g., d-cycloserine). It is also likely that these biomarkers may be relevant across different drugs of abuse, in particular nicotine, marijuana, cocaine, methamphetamine, and opiate use disorders.

More generally, the study of DNA methylation in the context of substance use is likely to have three broad clinical/commercial applications. First, the degree of DNA methylation of specific genes may represent a biological measure that reflects the severity of exposure to alcohol and drugs of abuse and the biological harm (e.g., risk for cancer) associated with that exposure. This is especially true for methylation sites in Tables 1 and 2 that demonstrated an association with number of years of drinking. For example, the degree of DNA methylation at sites related to cancer may represent the degree to which substance use has impacted an individual's risk for cancer. In other words, the degree of methylation of these sites could be used to predict an individual's risk of developing cancer if they continue to use substances. In that sense, it may also represent an important treatment tool (i.e., and assessment that could be used to increase a person's motivation to quit) and an important treatment outcome indicator (i.e., an indicator that the risk of cancer has been diminished as a result of treatment). Secondly, the degree of DNA methylation at these specific sites may be related to neurocognitive changes that underlie relapse and may predict treatment outcome. This is especially true for methylation sites associated with functional brain changes as identified in Tables 1 and 2 and the DRD2 and GLRA1 sites in particular. In other words, the degree of methylation at these particular sites may be a strong predictor of relapse after substance use treatment (who will get better and who will not), as described in the paragraph above. Thus, these biomarkers will likely represent an important target of treatments, given that the methylation status of these sites may be associated with relapse risk. For example, it may be important to test the methylation at these sites before and after a course of treatment to determine whether the treatment results in a change in the methylation status of these markers and hence a change in the risk for relapse. In addition, the degree of methylation of specific genes may be associated with acute alcohol binge drinking which may have important implications for identifying individuals who are engaged in binge drinking behavior. It is important to note that, while specific methylation sites are identified in Tables 1 and 2, these sites are a reflection of methylation in the general genome region, and it is this more general measure of methylation that is critical. Finally, it is important to note that while individual sites (e.g., the DRD2, GLRA1, and NPTX2 markers) may represent important individual biomarkers, the most consistent predictor of treatment outcome, or the consequences of long term use, or short term binge drinking may be the linear combination of methylation in genes associated with that particular measure in Tables FIGS. 1 and 2.

All patents and publications referenced or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications. Accordingly, the following references are hereby incorporated by reference:

Borrelli, E., Nestler, E. J., Allis, C. D., & Sassone-Corsi, P. (2008). Decoding the epigenetic language of neuronal plasticity. Neuron, 60, 961-974

Bredy T W, Sun Y E, Kobor M S. (2010). How the epigenome contributes to the development of psychiatric disorders. Dev Psychobiol. 52(4):331-42.

Crombag H S, Dickson M, Dinenna M, Johnson A W, Perin M S, Holland P C, Baraban J M, Reti I M. (2009). Narp deletion blocks extinction of morphine place preference conditioning, Neuropsychopharmacology, 34(4):857-66.

Hutchison, K. E. (2010). Substance Use Disorders: Realizing the Promise of Pharmacogenomics and Personalized Medicine. Annual Review of Clinical Psychology. 6, 577-589.

Johnson A W, Crombag H S, Takamiya K, Baraban J M, Holland P C, Huganir R L, Reti I M. (2007). A selective role for neuronal activity regulated pentraxin in the processing of sensory-specific incentive value. J Neurosci. 27(49):13430-5.

Moonat, S., Starkman, B. G., Sakharkar, A., & Pandey, S. C. (2010). Neuroscience of alcoholism: Molecular and cellular mechanisms. Cellular and Molecular Life Sciences, 67, 73-88.

Pacchioni, A M & Kalivas, P W (2009). The Role of AMPAR Trafficking Mediated by Neuronal Pentraxins in Cocaine-induced Neuroadaptations. Mol Cell Pharmacol, 1(2):183-192.

Pandey, S. C., Ugale, R., Zhang, H., Tang, L., & Prakash, A. (2009). Brain chromatin remodeling: A novel mechanism of alcoholism. The Journal of Neuroscience, 28, 3729-3737.

Petronis, A. (2010). Epigenetics as a unifying principle in the aetiology of complex traits and diseases, Nature, 465, 721-727.

Portela A, Esteller M. (2010). Epigenetic modifications and human disease. Nat Biotechnol. 28(10):1057-68.

Russo, S. J., Dietz, D. M., Dumitriu, D., Morrison, J. H., Malenka, R. C., & Nestler, E. G. (2009). The addicted synapse: Mechanisms of synaptic and structural plasticity in nucleus accumbens. Trends in Neurosciences, 33, 267-276

Tsankova, D., Renthal, W., Kumar, A., & Nestler, E. J. (2007). Epigenetic regulation in psychiatric disorders. Nature Reviews Genetics, 8, 355-367

Tsui, C. C., Copeland, N. G., Gilbert, D. J., Jenkins, N. A., Barnes, C., & Worley, P. F. (1996). Narp, a novel member of the pentraxin family, promoters neurite outgrowth and is dynamically regulated by neuronal activity. The Journal of Neuroscience, 16, 2463-2478.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. As used herein and in the appended claims, the singular forms “a,” “an,” and “the” include plural reference unless the context clearly dictates otherwise.

Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

What is claimed is:

1. An in vitro method for analyzing substance use by a human comprising:
obtaining a biological sample from the human; and
determining from the biological sample the DNA methylation status of one or more of the genes selected from the group consisting of: ACRBP′ ACSM3, ADRA2C, ADRA2C, AMN, ANKMY1, APIN, APOL1, ARL11, ATP8B2, B3GALT6, BAT2, BAZ2B, BRAF, BSN, C10orf7, C16orf24, C4orf7, C5orf13, C8B, C9orf89, C9orf90, CD164L2, CDC27, CDH1, CDKN2B, CHCHD1, CHD1L, CHST4, COMP, COX17, COX7A2, CRTAM, CTLA4, CTNNA1, CTNNA3, DIRAS3, DLGAP4, DLK1, DPF1, DPM1, DPP4, DRD2, DRD5, DSG1, EDARADD, ELMOD2, EMP3, EMR3, ERCC4, EXPH5, F2RL2, FAHD2A, FBLN2, FLJ12949, FLJ14834, FLJ22688, FLJ31659, FLJ33534, FLJ35816, FLJ38288, FLJ39575, FLJ42486, FN1, G6PC2, GALR1, GATA1, GATA4, GBP6, GDEP, GLRA1, GLTSCR1, GNAS, GNRH2, GPR156, GPR61, GPR62, GRIA2, GSTA3, GUCA1A, GYG2, H19, HADHA, HERV-FRD, HIF1AN, HIST1H1A, HIST1H4G, HLA-DOB, HM13, HRB2, HTR7, IGSF4C, IL1F7, IL24, IL8, KAAG1, KCNB1, KCNC3, KCNQ1DN, KLK13, KYNU, LEP, LOC126248, LOC129531, LOC339789, LOC387758, LRRC15, LRRC44, LTA, MAPK8IP1, MAPKAPK2, MAS1, MGC15476, MGC2803, MGC34830, MGMT, MPZ, MSX1, MYL7, MYST4, NDST4, NDST4, NEFH, NET1, NPTX2, NSF, OLR1, ORC1L, OTOS, PB1, PCDHGA12, PCDHGB4, PCSK1, PDE4C, PI3, PIGL, PKMYT1, PMM1, PPIE, PPP1R3A, PPP2R2B, PRKD3, PSMD5, PTGER1, PTPRN, PVALB, RAB27A, RAB4A, RABGGTB, RALGPS1, RASGEF1A, RB1, RBBP5, RGS13, RHBDD1, RIOK2, RLN1, RLN2, RLN3R2, RP11-49G10.8, RPS24, RPS9, RTP1, RUNX2, SAC, SACS, SAG, SCRN1, SCUBE1, SEC31L2, SELP, SF3B2, SFRP2, SLC10A4, SLC15A3, SLC17A8, SLC22A18, SLC22A6, SLC25A10, SLC2A8, SLC38A5, SMAP, SMPD3, SPINK4, SPRR2E, SST, SSTR1, STEAP4, TAS2R60, TBC1D5, TFAP2E, THRAP5, TIGD1, TJP2, TM7SF4, TMCO4, TMEM80, TMEM84, TMPRSS11A, TNFRSF10D, TNRC4, TRAF5, TRAPPC1, TRIM36, TRIM58, TRSPAP1, TTC13, TYR, VGF, WDR31, WT1, XRCC6, ZIM2, ZNF167, ZNF19, ZNF254, ZNF385, ZNF610, ZNF611, and ZNF96 and/or the DNA methylation markers selected from the group consisting of cg00010193, cg00014837, cg00055233, cg00393585, cg00401678, cg00415993, cg00521434, cg00536175, cg00548268, cg00564163, cg00662556, cg00687674, cg00842351, cg00885506, cg00891541, cg00911351, cg00967316, cg01112778, cg01128603 ,cg01155039, cg01337047, cg01355520, cg01416012, cg01459453, cg01498098, cg01530101, cg01667702, cg01708964, cg01765641, cg01775265, cg01946401, cg02075593, cg02091100, cg02121427, cg02151301, cg02157306, cg02169098, cg02255004, cg02276665, cg02286642, cg02431687, cg02442161, cg02510853, cg02630694, cg02655204, cg02682905, cg02701137, cg02784848, cg02978737, cg02994956, cg03017653, cg03021892, cg03054529, cg03148461, cg03382346, cg03389111, cg03417466, cg03491478, cg03679581, cg03775246, cg03804985, cg03837750, cg03958426, cg04076481, cg04084157, cg04304130, cg04384398, cg04456238, cg04457481, cg04570669, cg04576021, cg04622802, cg04762213, cg04810997, cg05023691, cg05113908, cg05114625, cg05206661, cg05294243, cg05310071, cg05436231, cg05480532, cg05535113, cg05593479, cg06131859, cg06168449, cg06214007, cg06244906, cg06291867, cg06421800, cg06504820, cg06563300, cg06566994, cg06572160, cg06646021, cg06796611, cg06933072, cg06971096, cg07321605, cg07338205, cg07506795, cg07510080, cg07533148, cg07549715, cg07584959, cg07599644, cg07605143, cg07660236, cg07694025, cg07703337, cg07713361, cg07730329, cg07799434, cg07829804, cg07845392, cg07871503, cg08072716, cg08096010, cg08126211, cg08190044, cg08209133, cg08433538, cg08460026, cg08510456, cg08525145, cg08657449, cg08749917, cg08784110, cg08789630, cg08818385, cg08906015, cg09118625, cg09212058, cg09222115, cg09419670, cg09457245, cg09458394, cg09511421, cg09538287, cg09547190, cg09555217, cg09599653, cg09604428, cg09781594, cg09786257, cg09809672, cg09830866, cg09936561, cg09949775, cg10036895, cg10146929, cg10177528, cg10235817, cg10269439, cg10384134, cg10431340, cg10468702, cg10523019, cg10585462, cg10586599, cg10620457, cg10691259, cg10693071, cg10905918, cg10906135, cg10936230, cg10964421, cg10977115, cg10995925, cg11120551, cg11126134, cg11161873, cg12335708, cg12439773, cg12758687, cg12782180, cg12799895, cg13206017, cg13434842, cg13599477, cg13759143, cg14081015, cg14717946, cg15846718, cg16463460, cg17861230, cg18302652, cg19093820, cg19497444, cg19515518, cg19945840, cg20831708, cg21263122, cg21615127, cg21644826, cg21992250, cg22172494, cg22464423, cg22511947, cg22832044, cg23293787, cg23392730, cg23540745, cg24091698, cg24358529, cg24507762, cg25002911, cg25148589, cg25842633, cg25958361, cg26050734, cg26372517, cg26687173, cg26808606, cg27038439, cg27504117, and cg27553955, wherein alteration of the methylation status of the one or more genes or methylations markers as compared to a control sample is associated with substance use.

2. The method of claim 1 wherein the substance is alcohol.

3. The method of claim 1 comprising determining the methylation status of at least one of the DRD2, NPTX2, GLRA1 and SELP genes.

4. The method of claim 1 further comprising determining the methylation status of the cg12758687 methylation marker.

5. The method of claim 1 further comprising determining the methylation status of ten or more of the genes identified in Tables 1 and 2.

6. The method of claim 1 further comprising determining the methylation status of twenty or more of the genes identified in Tables 1 and 2.

7. The method of claim 1 further comprising determining the methylation status of fifty or more of the genes identified in Tables 1 and 2.

8. The method of claim 1 further comprising determining the methylation status of ten or more of the methylations markers shown in Tables 1 and 2.

9. The method of claim 1 further comprising determining the methylation status of twenty or more of the methylation markers shown in Tables 1 and 2.

10. The method of claim 1 further comprising determining the methylation status of fifty or more of the methylation markers shown in Tables 1 and 2.

11. The method of claim 1 further comprising selecting a treatment plan for the human based on the determined methylation status.

12. The method of claim 10 wherein the treatment plan is a medication that targets dopamine receptors.

13. The method of claim 12 wherein at least one of the at least one or more genes is selected from the group consisting of the DRD2, GLRA1 or SELP genes.

14. The method claim 11 further comprising selecting a medication known to target proteins produced by one or more genes.

15. The method of claim 1 further comprising analyzing changes in the methylation status of the genes of Tables 1 and 2 in the human over time.

16. The method of claim 15 comprising determining the methylation status of the genes and/or methylation markers of Tables 1 and 2 before and after exposure of the human to a treatment method.

17. The method of claim 1 comprising predicting the human's risk for developing cancer based on the determined methylation status.

18. The method of claim 2 comprising predicting the human's risk for developing an alcohol use disorder based on the determined methylation status.
